(19) United States
(12) Patent Application Publication
(10) Pub. No.: US 2012/0313594 A1
(43) Pub. Date: Dec. 13, 2012

(54) STEP SWITCH

(76) Inventors: Oliver Brueckl, Waldmuenchen (DE); Udo Hertel, Regensburg (DE); Armin Hirthammer, Regensburg (DE); Anatoli Saveliev, Zeitlarn (DE)

(21) Appl. No.: 13/575,878

(22) PCT Filed: Dec. 23, 2010
(86) PCT No.: PCT/EP10/07934

§ 371 Date: Aug. 21, 2012

(30) Foreign Application Priority Data
Feb. 24, 2010 (DE) 10 2010 008 973.7

(51) Int. Cl. G05F 1/16

(52) U.S. Cl. 323/258

(57) ABSTRACT

The invention relates to a step switch comprising semiconductor switches for uninterrupted switching between tap windings of a step transformer. The switch is a hybrid switch that has fixed mechanical contact fingers and counter-contacts situated on a movable contact carrier. Semiconductor switch units are provided for the actual load switching, said units being actuated in a predetermined switching sequence by the contacts on the contact carrier.

The invention relates to a tap changer with semiconductor switching elements for uninterrupted switching over between winding taps of a tapped transformer.

A tap changer with semiconductor switching elements, which is constructed as a hybrid switch, is known from WO 01/22447. This known tap changer has, as hybrid switch, a mechanical part and an electrical part. The mechanical part, which is the actual subject of WO 01/22447, has mechanical switching contacts; the central part is a movable slide contact that is moved along a contact guide rail, which is connected with the star point, by means of a motor drive and in that case connects stationary contact elements. The actual load changeover itself is carried out by two IGBTs each with four diodes in a Graetz circuit. This known concept of a hybrid switch is subject to high mechanical loading in order to ensure the necessary load changeover precisely at the zero transition of the load current.

A further IGBT switching device is known from WO 97/05536, in which the taps of the regulating winding of a power transformer are connectable with a load shunt by way of a series circuit of two IGBTs. However, in this arrangement it is necessary to undertake a special adaptation of the tap changer to the respective tapped transformer that is to be connected.

The object of the invention is to indicate a tap changer of the kind stated in the introduction that is of simple construction and has a high level of functional reliability. Moreover, it is an object of the invention to indicate such a tap changer that is usable as standard apparatus for the most diverse tapped transformers without transformer-specific adaptation being needed.

These objects are fulfilled by a tap changer with the features of the first patent claim. The subclaims relate to particularly advantageous developments of the invention.

The invention starts from two semiconductor switching units, wherein each switching unit has two IGBTs in anti-parallel connection. Associated with each individual IGBT is a varistor connected in parallel therewith. In that case, the varistor is so dimensioned that the varistor voltage is smaller than the maximum blocking voltage of the respective parallel IGBTs, but greater than the maximum instantaneous value of the tap voltage.

As is usual in the case of tap changers of the hybrid type, the semiconductor switching units are switchable on and off by mechanical contacts and are connectable with the load shunt.

The invention shall be explained in more detail in the following by way of drawings, in which:

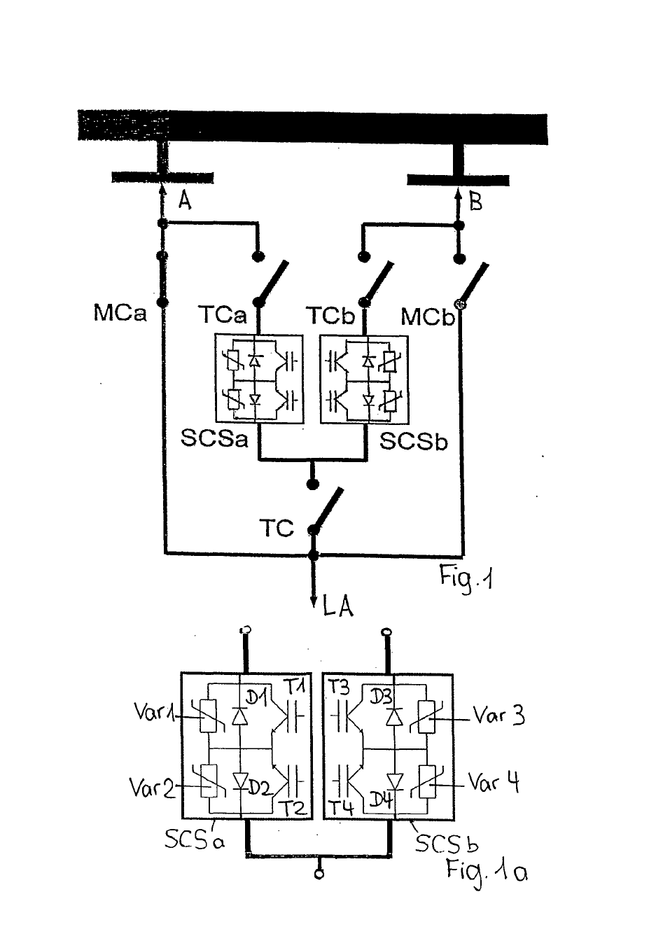

FIG. 1 shows a tap changer according to the invention in schematic illustration,

FIG. 1a shows an enlarged detail illustration of the semiconductor switching units shown in FIG. 1,

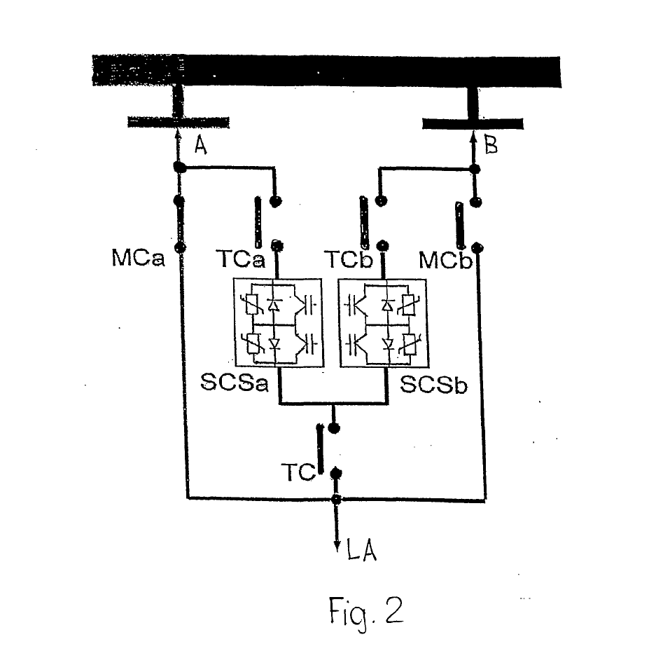

FIG. 2 shows a tap changer according to the invention in schematic illustration with an alternative contact construction,

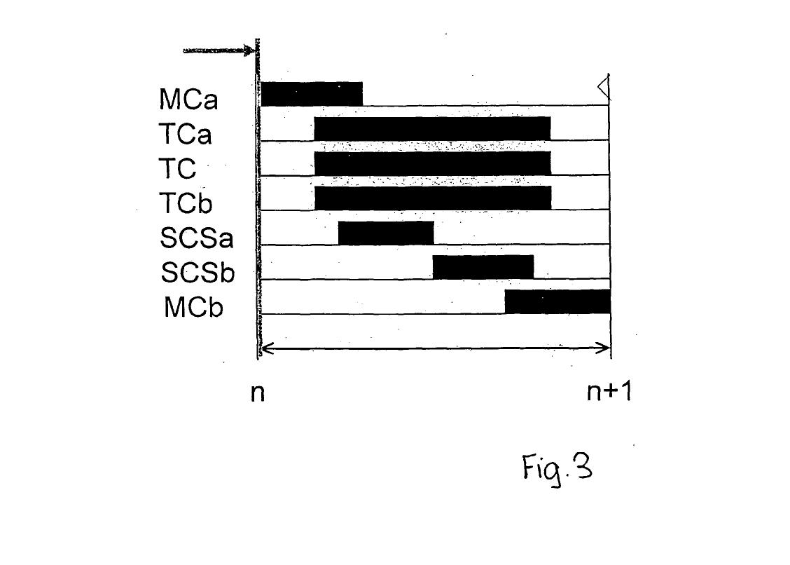

FIG. 3 shows a switching sequence in the case of switching over from one winding tap n to an adjacent winding tap n+1,

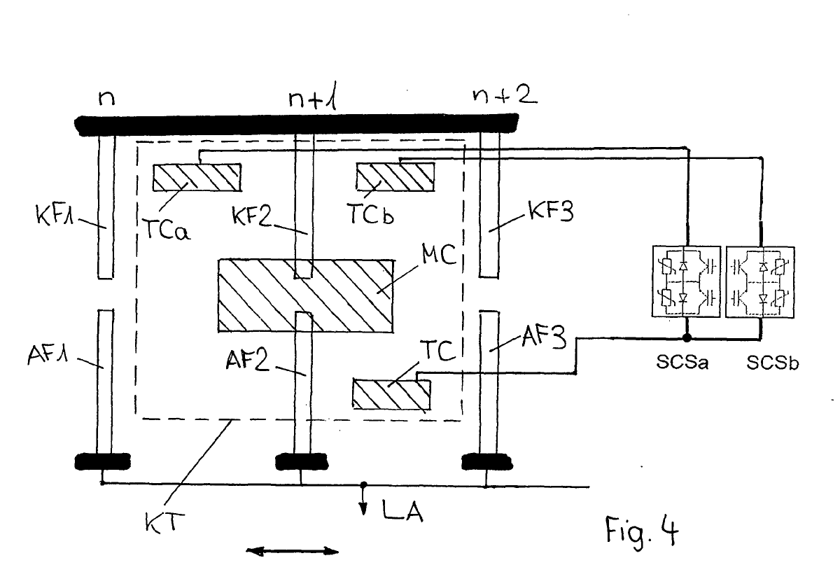

FIG. 4 shows a realization, in terms of apparatus, of a tap changer according to the invention in schematic illustration,

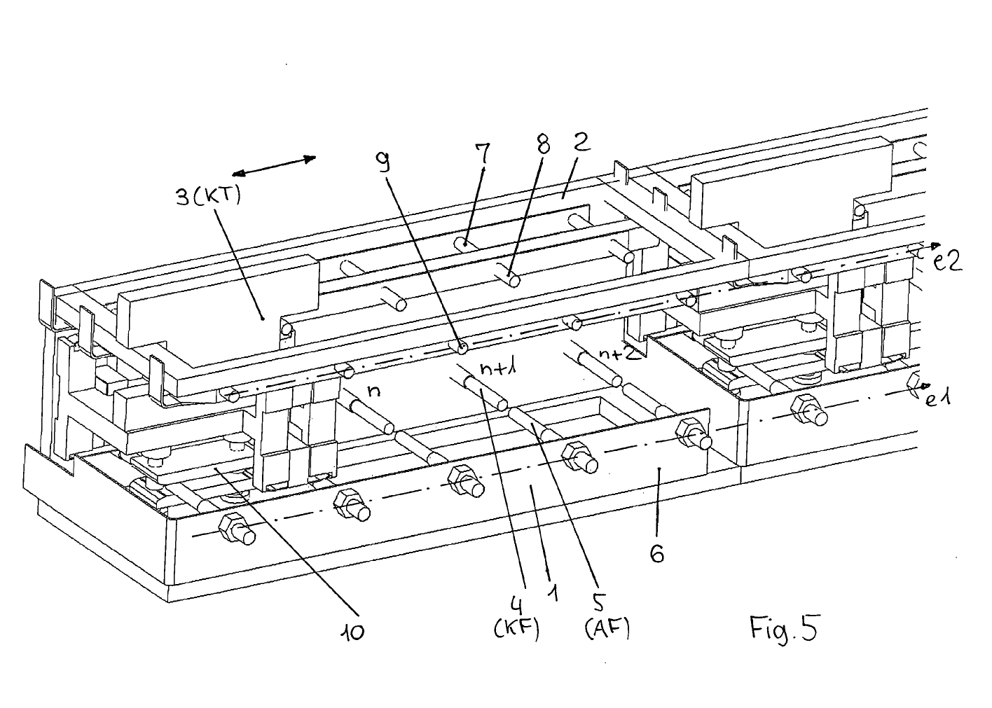

FIG. 5 shows the constructional form of such a tap changer according to the invention in perspective illustration,

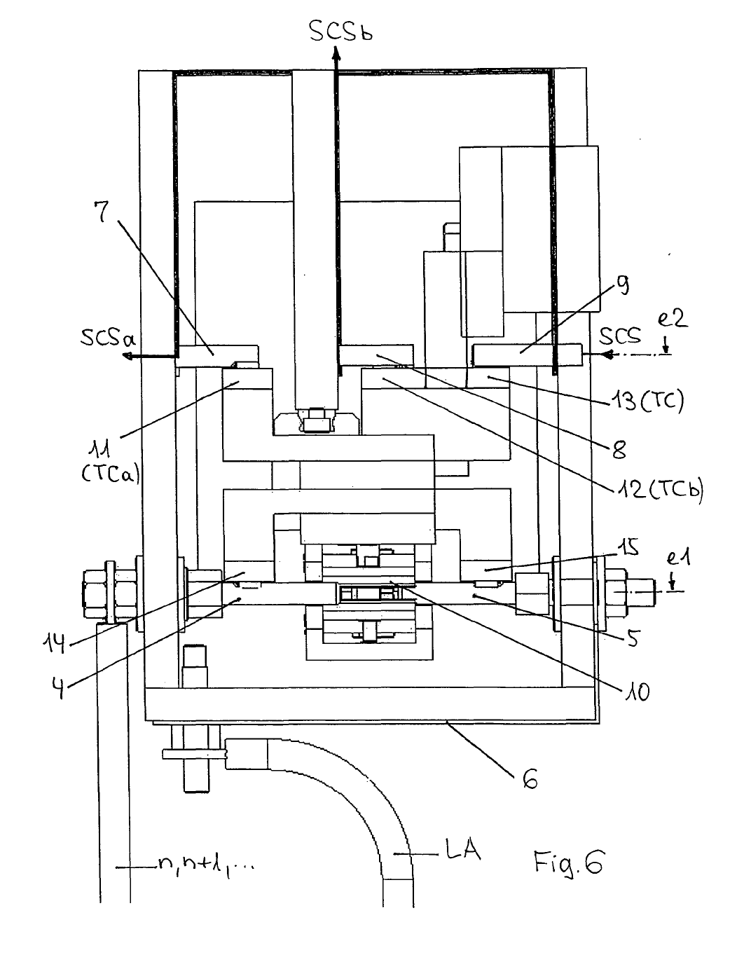

FIG. 6 shows a lateral sectional illustration thereof and

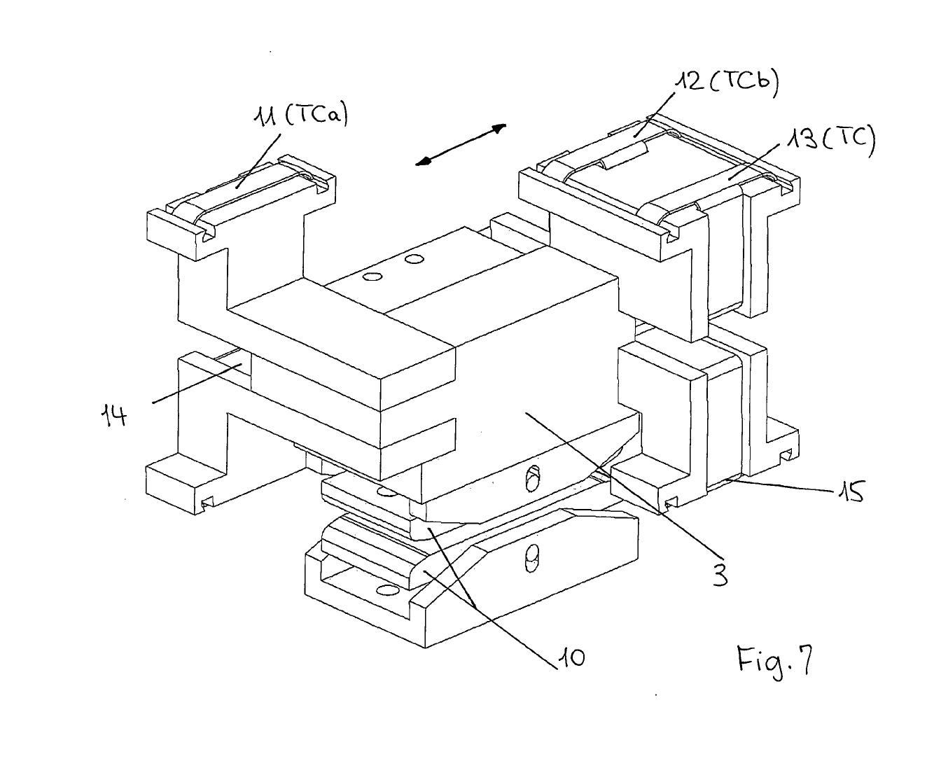

FIG. 7 shows a movable contact carrier of such a tap changer by itself in perspective illustration.

FIG. 1 shows a tap changer according to the invention. Illustrated here are two load branches A and B that are connectable with two winding taps with tapped transformer by a respective mechanical contact. Each of the two load branches A and B has a mechanical main contact MCa or MCb, which in stationary operation conducts the current of the respectively connected load branch and produces a direct connection with a load shunt LA. Each load branch A and B has in parallel with the respective main contact MCa or MCb a series circuit consisting of a further mechanical contact TCa or TCb as well as a respective semiconductor switching unit SCSa, SCSb. The semiconductor switch units SCSa, SCSb are electrically connected together at the side remote from the respective switch contacts TCa, TCb and lead to a mechanical transfer contact TC, the other side of which is connected with the load shunt LA. Thus, during the switching over, which will be explained in more detail further below, it is possible by appropriate actuation of the mechanical contact TCa or TCb as well as of the transfer contact TC to produce an electrical connection of each of the two load branches A and B by way of the respective semiconductor switching unit SCSa or SCSb with the load shunt LA.

FIG. 1a additionally shows the electronic subassemblies respectively shown on the right in FIG. 1 and later also in the following FIG. 2, i.e. semiconductor switching units SCSa, SCSb, in enlarged illustration. In that case, four IGBTs T1 . . . T4 are shown, of which two are connected in series relative to one another in each branch. In addition, a diode D1 . . . D4 is provided in parallel with each IGBT T1 . . . T4, wherein the diodes (D1, D2; D3, D4) in each branch are connected relative to one another. Moreover, a respective varistor Var1 . . . Var4 is in addition connected in parallel therewith.

The two semiconductor switching units SCSa, SCSb represent the actual semiconductor switch SCS. It consists, as already explained, of the following components: in total four IGBTs T1 . . . T4 are provided, of which two are in each path. The IGBTs are activated in pairs. If the load branch or path A is the side switching off, initially the IGBTs T1 and T2 are switched on. Since the current direction at the switch-over instant is random, the IGBTs are connected in series relative to one another. During the switching over to the other load branch or path B, the IGBTs 1 and 2 are switched off and the IGBTs of the other side are switched on almost simultaneously. Diodes D1 . . . D4 are provided in parallel with each IGBT T1 . . . T4. In addition, a respective varistor Var1 . . . Var4 is also connected in parallel therewith. These varistors serve for discharging or charging the stray impedances (stray inductances) of the transformer stage. It can be seen that the electrical circuit of the semiconductor switch SCS in each branch A or B is of identical construction and contains the described semiconductor switching units SCSa and SCSb. The electrical combination can be seen in the lower part of FIG. 1a, which leads to the transfer contact TC explained further above and not illustrated here.

FIG. 2 shows a tap changer according to the invention with, again, two load branches A and B. The already explained mechanical contacts TCa, TCb and TC are here constructed as doubled interrupting contacts.

FIG. 3 shows a switching sequence in the case of switching over of the tap changer from n to n+1. In that case, the following steps are executed:
Phase 1: Stationary operation at tap A. The current flows via the closed contact MCa to the load shunt LA. The semiconductor switching units SCSa, SCSb remain switched off, since all other mechanical switches are open.
Phase 2: Switching-on of the electronic system. The mechanical contacts TCa, TCb and TC are switched on almost simultaneously. The semiconductor switch SCS is thus supplied with electrical energy by way of the tap voltage.
Phase 3: Switching-on of the semiconductor switching subassembly SCSa. Since the electrical resistance of the mechanical contact group is low by comparison with that of the semiconductor components and of the remaining electronic components the current is initially still conducted by way of the mechanical contact Mca.
Phase 4: Opening of the main contact MCa. The current is thereby conducted by way of the semiconductor switching unit SCSa.
Phase 5: The electronic system switches over. The semiconductor switching unit SCSa is switched off; the semiconductor switching unit SCSb is switched on and takes over conducting of current.
Phase 6: The mechanical contact MCb of the other side B is switched on and now takes over conducting the current.
Phase 7: Switching-off of the semiconductor switching unit SCSb. As soon as the mechanical contact MCb is closed, the electronic system switches off the semiconductor switching unit SCSb of this branch.
Phase 8: Switching-off of the entire electronic system. The mechanical contacts TCa, TCb and TC are for that purpose switched off almost simultaneously. All electronic components are isolated from the voltage supply, i.e. the tap voltage. The load current is conducted from the side B via the closed mechanical main contact MCb directly to the load shunt LA. The switching over is concluded; the new static state is reached.

FIG. 4 shows a form of realization of the tap changer according to the invention, which is schematically illustrated in FIGS. 1 and 2 and that executes the switching sequence, which is illustrated in FIG. 3, at the time of switching over.

In that regard, winding taps, here n, n+1, n+2., are again shown, which are electrically connected with elongate, thin pencil-like fixed contact fingers KF1 . . . KF3. These contact fingers KF1 . . . KF3 are provided opposite respective further, similarly constructed elongate contact fingers AF1 . . . AF3 as shunt fingers, which are conductively connected together and form the load shunt LA. Provided above the contact fingers KF1 . . . KF3 and AF1 . . . AF3, which lie horizontally in a plane, on both sides is a contact carrier KT that is here indicated by dashed lines and that is movable perpendicularly to the length direction of the contact fingers. The movement direction is again symbolized by an arrow.

Arranged on the contact carrier KT on the side facing the contact fingers KF1 . . . KF3; AF1 . . . AF3 are contact members that are fixed on the contact carrier KT and are moved therewith in invariable geometric arrangement relative thereto. In that case, on the one hand this is the contact member MC that connects the respective winding tap directly in stationary operation—which is shown in FIG. 4—with the opposite contact finger of the load shunt LA. On the other hand, two separate further contact members TCa and TCb arranged laterally and symmetrically with respect thereto are provided. The contact member TCa is electrically connected with the input of the first semiconductor switching unit SCSa. The second contact member TCb is electrically connected with the input of the second semiconductor switching unit SCSb. Finally, a further contact member TC that is electrically connected with the output of the two semiconductor units SCSa, SCSb is additionally provided on the other side on the contact carrier KT. The explained further contact members—apart from the contact member MC—are geometrically so arranged that depending on the respective switching direction, the contact member TCa or TCb temporarily contacts one of the contact fingers KF1 . . . KF3 when the contact carrier KT moves. The contact member TC on the other side is geometrically arranged in such a manner that it produces temporary contact with one of the contact fingers AF1 . . . AF3 of the load shunt LA during a switching-over process, i.e. actuation of the contact carrier KT. In stationary operation, all these contact members TCa, TCb, TC are not connected; the electrical connection directly from the respectively connected winding tap, here n+1, to the load shunt LA takes place exclusively by the contact member MC, whilst the entire electronic system is cleared. The construction, which is shown in this embodiment, of the contacts—which are narrow in movement direction—as contact fingers in conjunction with the movable contacts—which are wide in movement direction—respectively constructed as a contact member makes possible overall a particularly advantageous, voltage-resistant form of the tap changer according to the invention.

The designation of the explained contact members in this figure corresponds with the designation of the mechanical switches in FIGS. 1 and 2, which they represent.

It is to be noted that regardless of the constructional form the circuit according to FIG. 1 or 2 and also the switching sequence according to FIG. 3 remain unchanged.

FIG. 5 shows, in schematic perspective illustration, the constructional form. A housing 1 with an upper housing support 2 is shown. A contact carrier 3, which is linearly displaceable in longitudinal direction of the housing 1 and that was designated in FIG. 4 as KT, is illustrated. The contact carrier 3 will be discussed in more detail later. Contact fingers 4 are provided in a first horizontal plane e1, which is indicated by a dot-dashed line and that are designated KF in FIG. 4. Further contact fingers 5 are arranged respectively opposite as shunt fingers and are denoted AF in FIG. 4. All shunt fingers 5 are electrically connected together by means of a connecting plate 6 and led to the load shunt. Contact fingers 7 are arranged in a second horizontal plane e2, which is arranged parallel thereto, and on a side of the housing 1, further contact fingers 8 are arranged in the center on a separate carrier and further contact fingers 9 are arranged on the other side again in the second horizontal plane e2.

It is to be noted that all contact fingers 4, 5; 7, 8, 9 are arranged at the same grid spacing; in each instance, for reasons of clarity only one of each kind of the contact fingers is provided with reference numerals. The contact carrier 3 has at its lower region a two-part main contact 10 as contact member MC, which at the respectively opposite, corresponding contact finger 4 is electrically connected with the respective shunt finger 5 and thus produces in stationary operation a direct connection with the load shunt, as is shown in FIGS. 1 and 2.

The contact fingers 7 are respectively electrically connected with the input of the first semiconductor switching unit SCSa. The contact fingers 8 are respectively connected with the input of the second semiconductor switching unit SCSb. Finally, the contact fingers 9 are electrically connected with the common output of the two semiconductor switching units SCSa, SCSb.

These electrical connections are, in fact, shown in FIG. 4, but here for reasons of clarity not illustrated in FIG. 5, any more than the drive of the contact carrier 3.

FIG. 6 shows this arrangement in lateral sectional illustration. It can be clearly seen here that the contact fingers 4 and 5 are arranged in a first horizontal plane e1 and the contact fingers 7, 8, 9 in a second horizontal plane e2. It can also be seen that the contact carrier 3 has, apart from the described main contact 10, contact members 11, 12 and 13, which respectively co-operate, i.e. can be connected, with the contact fingers 7 or 8 or 9, in the upper region.

The contact carrier 3 has at its lower part further contact members 14, 15. Contact member 14 can connect the respective contact finger 4; contact member 15 can connect the respective contact finger 5. It is important for the function that the contact members 11 and 12 are electrically connected with the contact member 14, whereagainst the contact member 13 is electrically connected with the contact member 15. The contact carrier 3 thus connects electrical contact members 11, 12, 13 of the upper plane e2 with contact members 14, 15 of the lower plane e1 in an entirely specific manner. In this form of embodiment of the invention as well, the contact fingers 4, 5; 7, 8, 9 are constructed as pencil-like contact fingers that are narrow as seen in movement direction of the contact carrier and that are fastened only at one end, whereas the contact members 11, 12, 13; 14, 15 as well as the main contact 10 have a substantially larger length, preferably at least three times, in movement direction of the contact carrier 3.

FIG. 7 shows a contact carrier 3 by itself in perspective illustration. Here at the outset the lateral contact members 14, 15 arranged in the lower horizontal plane as well as the main contact 10 can be seen. The contact members 11, 12 and 13, which are laterally offset in movement direction (indicated by an arrow), are shown in the upper horizontal plane. The contact member 11 corresponds in its function with the contact TCa: it produces the connection with the input of the first semiconductor switching unit SCSa. The contact member 12 corresponds with a contact TCb: it produces the connection with the input of the second semiconductor switching unit SCSb. The contact member 13 corresponds with the contact TC: it produces the connection with the common output of the two semiconductor switching units SCSa, SCSb. Precisely the electrical and mechanical construction schematically illustrated in FIG. 4 is thus realized.

On movement of the contact carrier 3 the first or second semiconductor switching unit SCSa or SCSb, depending on the respective switching direction, is supplied with electrical energy by way of the respective contact member 11, corresponding with TCa, or 12, corresponding with TCb, which is respectively temporarily electrically connected with a fixed tap contact. The common output of the semiconductor switching units SCSa and SCSb is then led by way of the contact member 13, corresponding with TC, back again to the load shunt.

In the embodiment, two horizontal planes were described; it is equally also possible within the scope of the invention to vertically arrange the two planes, which run in parallel.

In summary, the function of the contact carrier 3 can be described in the following terms: In stationary operation it produces a direct connection of a winding tap with the load shunt in that a corresponding contact finger 4 is electrically connected with the corresponding contact finger 5 of the load shunt by the main contact 10. During the switching over, thereagainst, this direct contacting is interrupted and the respective semiconductor switching unit SCS1 or SCS2 is temporarily switched on by contact member 11 or 12 in another horizontal plane and the (common) output of that switching unit is led by the further contact member 13 back again in the first horizontal plane to the contact member 15 and on to the contact finger 5 of the load shunt 6. The actual switching planes, i.e. the horizontal planes e1, are characteristic, as is the auxiliary switching plane, i.e. the plane e2, for temporary switching-on of the semiconductor switching units during a switching-over process.

1. A tap changer with semiconductor switching elements for uninterrupted switching over between winding taps of a tapped transformer, wherein two load branches connected with winding taps of the tapped transformer are provided, wherein each of the two load branches comprises a mechanical main contact that in stationary operation conducts the current of the respectively connected load branch and produces an electrical connection with a load shunt, wherein each load branch comprises parallel to the respective main contact a series circuit consisting of a further mechanical contact as well as a respective semiconductor switching unit, wherein the semiconductor switching units are electrically connected together at the side remote from the respective contacts and lead to a mechanical transfer contact, the other side of which is connected with a load shunt, and wherein the connection of the main contacts as well as the further mechanical contacts is effected by a movable contact carrier.

2. The tap changer according to claim 1, wherein fixed contact fingers arranged parallel to one another are provided in a first plane and are each connected with a respective winding tap of the tap changer, further, similarly constructed elongate contact fingers are provided oppositely in the same plane and are conductively connected together and lead to the load shunt, a contact carrier is provided on both sides above the contact fingers lying in a plane and is movable perpendicularly to the length direction of the contact fingers, contact members able to be connected with the respective contact fingers are provided on the contact carrier on the side towards the contact fingers, a contact member in stationary operation produces the direct electrical connection with the load shunt, a further contact member is electrically connected with the input of the first semiconductor switching unit, a further contact member is electrically connected with the input of the second semiconductor switching unit and yet a further contact member is electrically connected with the common output of the two semiconductor switching units.

3. The tap changer according to claim 2, wherein several further contact fingers are provided respectively in a line in a second plane, the first row of contact fingers is electrically connected with the input of the first semiconductor switching unit, the second row of contact fingers is electrically connected with the input of the second semiconductor switching unit, the third row of contact fingers is electrically connected with the common output of the two semiconductor switching units and during the switching-over process contact fingers of the upper plane can be temporarily brought into electrical connection with the respective contact fingers in the first plane by the contact carrier by means of further contact members.

4. The tap changer according to claim 2, wherein the length direction of all contact members as seen in the direction of movement of the contact carrier is at least three times the thickness of the contact fingers.
